(19) United States
(12) Patent Application Publication
(10) Pub. No.: US 2022/0327453 A1
(43) Pub. Date: Oct. 13, 2022

(54) SYSTEM AND METHOD FOR INFRASTRUCTURE CAPACITY PLANNING OF CLOUD COMPUTING RESOURCES

(71) Applicant: International Business Machines Corporation, Armonk, NY (US)

(72) Inventors: Chuan Ran, Morrisville, NC (US); Oluwanifemi Oluyemi, Toronto (CA); Vamsee Movva, Cary, NC (US); Daniel Dolphin, Willow Spring, NC (US); A. Jaylani Sharif, Ashburn, VA (US)

(21) Appl. No.: 17/225,591

(22) Filed: Apr. 8, 2021

(51) Int. Cl. G06Q 10/06; G06F 9/50

(52) U.S. Cl. CPC G06Q 10/06315; G06F 9/5083

(57) ABSTRACT

A computer-implemented system, method and computer program product for predicting cloud computing resources to add to a cloud computing system that includes: determining a total current size of available computing resources; determining a predicted size of faulty computing resources; determining a confirmed size of computing resources already provisioned; and/or determining a potential size of needed computing resources based upon analysis of customer-specific data; and predicting the cloud computing resources needed to be added to the cloud computing system using the total current size of available computing resources; the predicted size of faulty computing resources; the confirmed size of computing resources already provisioned; and/or the potential size of needed computing resources based upon analysis of customer-specific data.

### FIELD

The present application relates generally to information handling and/or data processing systems, and more particularly to cloud computing and infrastructure capacity planning provisioning of cloud computing resources.

### BACKGROUND

Cloud computing is becoming increasingly popular as more and more enterprises utilize varying degrees of cloud computing resources available from a number of vendors. A cloud computing environment is a scalable computer system or network that can provide a system of “computers” that can be provisioned to create or provide an environment that mimics a desired hardware and software environment. One of the benefits of cloud computing environments is that they provide a scalable environment or an environment that can be created on demand. A user of cloud computing resources often needs to specify the hardware, e.g., a set of specifications, for the user's cloud computing environment. For example, the user might have to specify CPU resources, memory, storage, the number of bits of the platform (e.g., 32 bit, 64 bit application platforms), I/O resources and other hardware information. The user might also have to specify software applications including, but not limited to, operating systems, database server applications, batch processing applications, web hosting applications, application servers, media servers, and other software.

The cloud computing provider or vendor needs to be able to plan for additional infrastructure resources that its customers might require. Capacity planning on the part of a cloud computing vendor plays an important role in preparing additional infrastructure resources to minimize potential issues with customers and maximize customer satisfaction. Capacity planning that takes into account infrastructure resource/workload analysis and customer related data would be advantageous.

### SUMMARY

The summary of the disclosure is given to aid understanding of, and not with an intent to limit the disclosure. The present disclosure is directed to a person of ordinary skill in the art. It should be understood that various aspects and features of the disclosure may advantageously be used separately in some circumstances or instances, or in combination with other aspects, embodiments, and/or features of the disclosure in other circumstances or instances. Accordingly, variations and modifications may be made to the system and/or method to achieve different effects. In this regard it will be appreciated that the disclosure presents and describes one or more inventions, and in aspects includes numerous inventions as defined by the claims.

A system, method and/or computer program product is disclosed for determining and/or predicting the amount of needed cloud computing resources is disclosed, and in an aspect determining and/or predicting the amount of cloud computing infrastructure resources a cloud computing provider will need in the future. In an embodiment the system, method, and/or computer program product determines and/or predicts the size of computing resources needed using customer-specific data, and in an aspect using infrastructure data as well. In one or more embodiments, a computer-implemented method, system, and/or programming instructions for predicting cloud computing resources to add to a cloud computing system is disclosed that includes: determining a total current size of available computing resources; determining a predicted size of computing resources that are expected to be faulty; determining a confirmed size of computing resources already provisioned; and/or determining a potential size of needed computing resources based upon analysis of customer-specific data; and predicting the cloud computing resources needed to be added to the cloud computing system includes using the total current size of available computing resources; the predicted size of computing resources that are expected to be faulty; the confirmed size of computing resources already provisioned; and/or the potential size of needed computing resources based upon analysis of customer-specific data.

The system, method, and/or computer program product in an aspect further includes determining a workload size of computing resources to meet potential workload increases in computing resources, and predicting the cloud computing resources needed to be added to the cloud computing system includes using the workload size of computing resources to meet potential workload increases in computing resources. Predicting the cloud computing resources needed to be added in an aspect is performed on a computing resource-by-resource basis, and additionally or alternatively determining the potential size of needed computing resources based upon analysis of customer-specific data is performed on a customer-by-customer basis. The computing resources includes, but is not limited to, at least one of a group consisting of: CPU, RAM, storage, servers, BareMetal servers, Network bandwidth, IP Addresses, Network Interface Cards (NICs), Power, and combinations thereof.

In one or more embodiments, determining the potential size of needed computing resources based upon analysis of customer-specific data includes determining a customer's sentiment level on provisioning new computing resources using customer specific data. In an aspect, determining a customer's sentiment level on provisioning new computing resources comprises reviewing at least one of a group consisting of: customer social media data, customer call data, and combinations thereof. In a further aspect, reviewing at least one of a group consisting of customer social media data, customer call data, and combinations thereof comprises using at least one of a group consisting of machine learning algorithms, natural language processing algorithms, data science algorithms, and combinations thereof. In one or more embodiments, determining the potential size of needed computing resources based upon analysis of customer-specific data additionally or alternatively includes determining a customer's value using customer-specific data, wherein determining a customer's value comprises reviewing at least one of the group consisting of customer relationship management data, business support system data, and combinations thereof. Determining the potential size of needed computing resources based upon analysis of customer-specific data in an aspect includes calculating a frequency of a customer's provisioning requests, wherein calculating a frequency of a customer's provisioning requests comprises reviewing historical data using enterprise operations management tools. In a further aspect, determining a customer's sentiment level, determining a customer's value, and determining a frequency of a customer's provisioning requests includes using at least one of a group consisting of machine learning algorithms, natural language processing algorithms, data science algorithms, and combinations thereof. In a further embodiment, determining the potential size of needed computing resources based upon analysis of customer-specific data further comprising inputting into a decision tree at least one of a group consisting of the customer's sentiment level on provisioning new computing resources; the customer's value; and the frequency of a customer's provisioning requests.

In an aspect, determining the potential size of needed computing resources based upon analysis of customer-specific data includes determining the propensity of a customer to increase or decrease its cloud computing needs based upon analysis of customer-specific data and determining the size of the computing resource increase or decrease, wherein determining the size of the computing resource increase or decrease increases using at least one of a group consisting of: a size of computing resources expressed by the customer, an average size of computing resources based upon historical usage by the customer, a weighted average of computing resources that takes into account trends in historical usage by the customer, a seasonally weighted average of computing resources that takes into account calendar year based changes by the customer, and combinations thereof. Determining the potential size of computing resource needs based upon analysis of customer-specific data further includes in an embodiment using at least one of a group consisting of machine learning algorithms, natural language processing algorithms, data science algorithms, and combinations thereof.

The foregoing and other objects, features, and/or advantages of the invention will be apparent from the following more particular descriptions and exemplary embodiments of the invention as illustrated in the accompanying drawings wherein like reference numbers generally represent like parts of the illustrative embodiments of the invention.

### BRIEF DESCRIPTION OF THE DRAWINGS

The various aspects, features, and/or embodiments of a system and/or method to calculate the amount of needed cloud computing resources, and in an aspect predicting the amount of cloud computing infrastructure resources using customer specific data, will be better understood when read in conjunction with the figures provided. Embodiments are provided in the figures for the purpose of illustrating aspects, features, and/or various details of the systems and methods, but the claims should not be limited to the precise arrangement, features, aspects, embodiments, systems, modules, functional units, programming, instructions, methods, processes, techniques, and/or devices shown, and the arrangements, features, aspects, embodiments, systems, modules, functional units, programming, instructions, methods, processes, techniques, and/or devices shown may be used singularly or in combination with other arrangements, features, aspects, embodiments, systems, modules, functional units, programming, instructions, methods, techniques, processes, and/or devices.

FIG. 1 depicts a cloud computing environment according to an embodiment of the disclosure;

FIG. 2 depicts abstraction model layers of a cloud computing environment according to an embodiment of the disclosure;

FIG. 3 illustrates an exemplary computer system in accordance with the present disclosure to calculate the amount of cloud computing resources required in the future, and in an aspect predict the amount of cloud computing resources using infrastructure related and customer specific data;

FIG. 4 schematically depicts an exemplary computer system/computing device which is applicable to implement one or more embodiments of the present disclosure to predict the cloud computing capacity required in the future, and in an aspect predict the amount of cloud computing resources using customer specific data;

FIG. 5 schematically illustrates an embodiment of an overview diagram of a method/system to implement one or more embodiments of the present disclosure to predict the amount of needed cloud computing resources in the future;

FIG. 6 diagrammatically illustrates a diagram to calculate P(i) using customer specific data;

FIG. 7 illustrates a diagrammatic flowchart of a method according to an embodiment of the present disclosure of predicting cloud computing resource needs; and

FIG. 8 illustrates a diagrammatic flowchart of a method according to an embodiment of the present disclosure of predicting a potential size and/or amount of needed cloud computing resources based upon an analysis of customer-specific data.

### DETAILED DESCRIPTION

The following description is made for illustrating the general principles of the invention and is not meant to limit the inventive concepts claimed herein. In the following detailed description, numerous details are set forth in order to provide an understanding of the system, method, and/or techniques of the invention for calculating needed cloud computing resources, and in an aspect predicting needed cloud computing resources using customer specific data. It will be understood, however, by those skilled in the art that different and numerous embodiments of the system and/or method of the invention may be practiced without the specific details, and the claims and disclosure should not be limited to the arrangements, systems, devices, modules, functional units, programming, instructions, embodiments, features, aspects, processes, methods, techniques, and/or details specifically described and shown herein. Further, particular features, aspects, embodiments, arrangements, systems, devices, modules, functional units, programming, instructions, methods, processes, techniques, details, etc. described herein can be used in combination with other described features, aspects, embodiments, arrangements, structures, systems, devices, modules, functional units, programming, instructions, techniques, methods, processes, details, etc. in each of the various possible combinations and permutations.

It is assumed that those skilled in the art are familiar with cloud computing environments, including cloud computing architecture, infrastructure, resources and operations. The following discussion omits or only briefly describes conventional features of information processing systems, data networks, and/or cloud computing environments, including cloud computing architecture, infrastructure, resources and operations, which should be apparent to those skilled in the art. It may be noted that a numbered element is numbered according to the figure in which the element is introduced, and is typically referred to by that number throughout succeeding figures.

Cloud computing is a model of service delivery for enabling convenient, on-demand network access to a shared pool of configurable computing resources (e.g., networks, network bandwidth, servers, processing, memory, storage, applications, virtual machines, and services) that can be provisioned and released through a service provider or vendor. This model can include one or more characteristics, one or more service models, and one or more deployment models. Characteristics can include, for example, on-demand service; broad network access; resource pooling; rapid elasticity; and/or measured service. Service models can include, for example, software as a Service (SaaS), Platform as a Service (PaaS), and/or Infrastructure as a Service (IaaS). Deployment models can include, for example, private cloud; community cloud; public cloud; and/or hybrid cloud.

A cloud computing environment is typically service oriented with a focus on statelessness, low coupling, modularity, and semantic interoperability. Typically at the heart of cloud computing is an infrastructure that includes a network of interconnected nodes. To provide on-demand service, resource pooling, rapid elasticity, and service to its customers, capacity planning plays an important role for a cloud computing provider. A cloud computing provider/vendor needs to prepare additional cloud computing infrastructure resources in advance to meet customer on-demand service expectations, to minimize a shortage of computing resources, and to maximize customer satisfaction. In this regard, some of the cloud computing resource types that could be part of the cloud computing capacity planning and calculations includes, but is not limited to, CPU, RAM, storage, servers, BareMetal servers, Network bandwidth, IP Addresses, Network Interface Cards (NICs), Power, etc.

It would be advantageous to utilize cognitive based cloud computing resource capacity planning to predict the amount of cloud computing resources a cloud computing vendor will need at the present, and/or in the future. It would be advantageous to leverage a set of data science and machine learning algorithms to provide detailed quantitative analysis of future cloud computing capacity requirements, for example, calculate the confirmed amount of computing resources that needs to be reserved, and/or predict customers that have a potential need to expand or increase use of cloud computing infrastructure resources in the future. It would be further advantageous to provide a detailed, comprehensive analysis to calculate how much computing infrastructure resources may need to be added by a cloud computing vendor to meet customer future demand, including in an aspect that takes into consideration customer-specific data, for example, customer relationship management (CRM) data and/or business support system (BSS) data, social media data, customer call data, etc. It would be further advantageous to provide a detailed, comprehensive analysis to calculate how much computing infrastructure resources may need to be added by a cloud computing vendor to meet customer future demand, including in an aspect that takes into consideration infrastructure-related data. It would be advantageous to utilize cognitive based capacity cloud computing resource planning that leverages and/or uses both infrastructure related data and customer specific data.

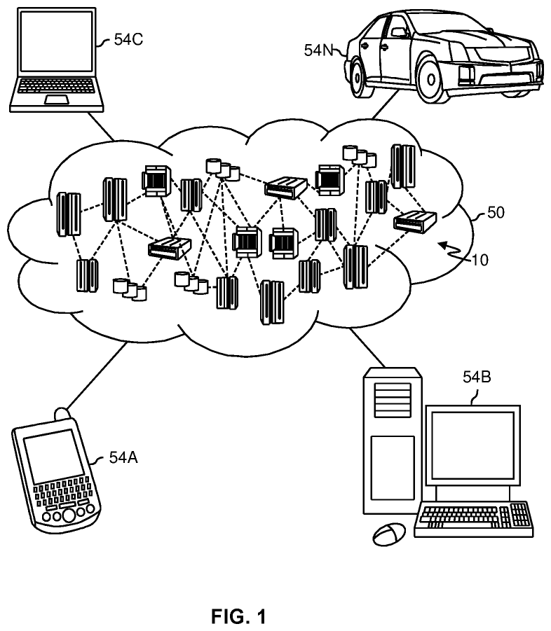

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or mobile (smart) telephone 54A, desktop computer 54B, laptop computer 54C, and/or automobile computer system 54N may communicate. Nodes 10 may communicate with each other. They may be grouped (not shown) physically or virtually, in one or more networks, such as Private, Community, Public, or Hybrid clouds, or a combination thereof. This allows cloud computing environment 50 to offer infrastructure, platforms and/or software as services for which a cloud consumer does not need to maintain resources on a local computing device. It is understood that the types of computing devices 54A-54N shown in FIG. 1 are intended to be illustrative only and that computing nodes 10 and cloud computing environment 50 can communicate with any type of computerized device over any type of network and/or network addressable connection (e.g., using a web browser).

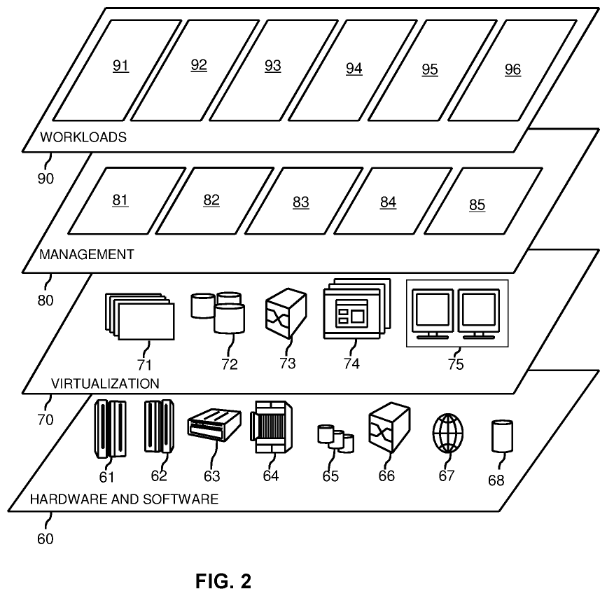

Referring to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware (e.g., infrastructure) components can include: mainframes 61; RISC (Reduced Instruction Set Computer) architecture based servers 62; servers 63; blade servers 64; storage devices 65; and network and networking components 66. In some embodiments, software components include network application server software 67 and database software 68.

Virtualization layer 70 provides an abstraction layer from which the flowing examples of virtual entities may be provided: virtual servers 71; virtual storage 72; virtual networks 73, including virtual private networks; virtual applications and virtual operating systems 74; and virtual clients 75.

In one example, management layer 80 may provide the functions described below. Resource provisioning 81 provides procurement, preferably dynamic procurement, of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; and transaction processing 95. Other functionality as illustrated by workload layer 96 is contemplated.

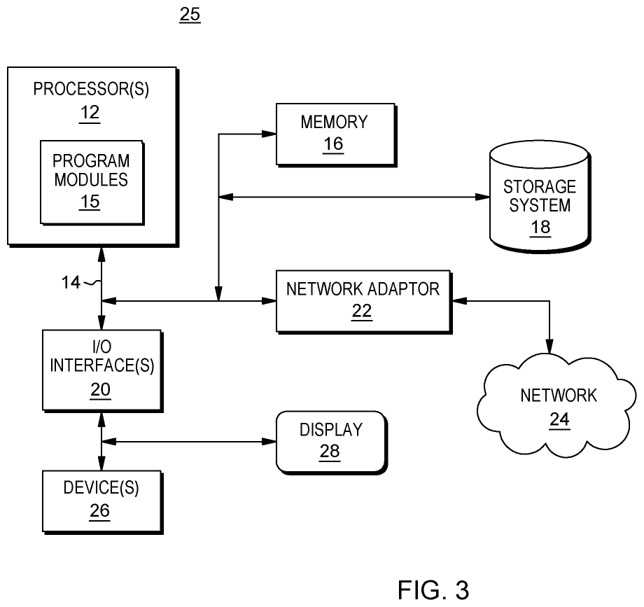

FIG. 3 illustrates an example computing system 25 in accordance with the present disclosure that can be used to plan, calculate, and/or predict cloud computing resource capacity requirements. It is to be understood that the computer system depicted is only one example of a suitable electronic computer system and is not intended to suggest any limitation as to the scope of use or functionality of embodiments of the present invention. For example, the system shown may be operational with numerous other general-purpose or special-purpose computing system environments or configurations. Examples of well-known computing systems, environments, and/or configurations that may be suitable for use with the system shown in FIG. 3 may include, but are not limited to, mainframe computer systems, server computer systems, thin clients, thick clients, personal computers, networked computers, minicomputer systems, handheld or laptop devices, tablets, smart phones, multiprocessor systems, microprocessor-based systems, set top boxes, programmable consumer electronics, and distributed cloud computing environments that include any of the above systems or devices, and the like.

In some embodiments, the computer system 25 may be described in the general context of computer system executable instructions, embodied as program modules or software programs stored in memory 16, being executed by the computer system. Generally, program modules may include routines, programs, objects, components, logic, data structures, and so on that perform particular tasks and/or implement particular input data and/or data types in accordance with the present invention.

The components of the computer system 25 may include, but are not limited to, one or more processors or processing units 12, a memory 16, and a bus 14 that operably couples various system components, including memory 16 to processor 12. In some embodiments, the processor 12 may execute one or more program modules 15 that are loaded from memory 16, where the program module(s) embody software (program instructions) that cause the processor to perform one or more method embodiments of the present invention. In some embodiments, program module 15, e.g., software programs, may be programmed into the circuits of the processor 12, loaded from memory 16, storage device 18, network 24, and/or combinations thereof. It is generally appreciated that processor 12 contains circuits including integrated circuits to perform operations of the processor 12.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system 25 may include a variety of computer system readable media. Such media may be any available media that is accessible by the computer system, and it may include both volatile and non-volatile media, removable and non-removable media. Memory 16 (sometimes referred to as system memory) can include computer readable media in the form of volatile memory, such as random access memory (RAM), cache memory, and/or other forms of memory. Computer system 25 can further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

The computer system 25 can also communicate with one or more external devices 26 such as a keyboard, a pointing device, a display 28, etc.; one or more devices that enable a user to interact with the computer system; and/or any devices (e.g., network card, modem, etc.) that enable the computer system to communicate with one or more other computing devices. Such communication can occur via Input/Output (I/O) interfaces 20.

Still yet, the computer system 25 can communicate with one or more networks 24 such as a local area network (LAN), a general wide area network (WAN), and/or a public network (e.g., the Internet) via network adapter 22. In the present disclosure, one or more of the networks 24 with which computer system 25 would communicate would be the cloud computing provider or vendor. As depicted, network adapter 22 communicates with the other components of computer system via bus 14. It should be understood that although not shown, other hardware and/or software components could be used in conjunction with the computer system. Examples include, but are not limited to: microcode, device drivers, redundant processing units, external disk-drive arrays, RAID systems, tape drives, and data archival storage systems, etc.

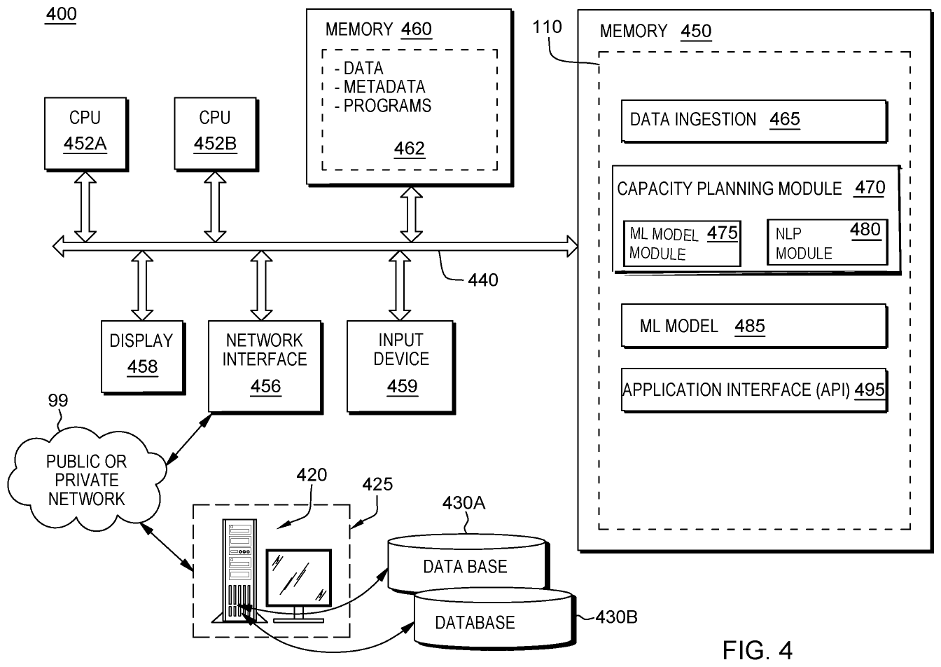

FIG. 4 illustrates a computer system 400 configured and programmed for use in planning, predicting, and/or calculating needed cloud computing resources in the future, for example, calculating cloud computing infrastructure resources using customer-specific data. In one or more embodiments, such a system tool 400 may be employed by or for a cloud computing provider or vendor, for example International Business Machine (IBM) cloud computing services. In one or more aspects, computing system 400 may include, for example, mainframe computers, servers, distributed cloud computing environments, thin clients, thick clients, personal computers (PCs), computer networks, laptops, tablets, mini-computers, multi-processor based systems, micro-processor based systems, smart devices, smart phones, set-top boxes, programmable electronics, or any other similar computing device, an embodiment of which is described in more detail in FIG. 3.

Computing system 400 includes one or more hardware processors 452A, 452B (also referred to as central processing units (CPUs)); a memory 450, e.g., for storing an operating system (OS), application program interfaces (APIs), and program modules/instructions; a network interface 456; a display device 458; an input device 459; and can include any other features common or uncommon to a computing device. In some aspects, computing system 400, for example, can be configured to communicate with a customer computing environment 425 that can include computing devices 420 over a public or private communications network 99. Customer computing environment 425 can include one or more databases 430A & 430B.

In the embodiment depicted in FIG. 4, processors 452A, 452B may include, for example, a microcontroller, Field Programmable Gate Array (FPGA), or any other processor that is configured to perform various operations. Communication channels 440, e.g., wired connections such as data bus lines, address bus lines, Input/Output (I/O) data lines, video bus, expansion busses, etc., are shown for routing signals between the various components of system 400. Processors 452A, 452B are configured to execute instructions as described below. These instructions may be stored, for example, as programmed modules in an associated memory storage device 450.

Memory 450 may include, for example, non-transitory computer readable media in the form of volatile memory, such as random access memory (RAM) and/or cache memory or other forms of memory. Memory 450 may include, for example, other removable/non-removable, volatile/non-volatile storage media. By way of non-limiting examples only, memory 450 may include a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Network interface 456 is configured to transmit and receive data or information to and from customer computing environment 425, e.g., a computing resource, via wired or wireless connections. For example, network interface 456 may utilize wireless technologies and communication protocols such as Bluetooth®, WIFI (e.g., 802.11a/b/g/n), cellular networks (e.g., CDMA, GSM, M2M, and 3G/4G/4G LTE, 5G), near-field communications systems, satellite communications, via a local area network (LAN), via a wide area network (WAN), or any other form of communication that allows computing device 400 to transmit information to or receive information from the customer computing environment 425.

Display 458 may include, for example, a computer monitor, television, smart television, a display screen integrated into a personal computing device such as, for example, laptops, smart phones, smart watches, virtual reality headsets, smart wearable devices, or any other mechanism for displaying information to a user. In some aspects, display 458 may include a liquid crystal display (LCD), an e-paper/e-ink display, an organic LED (OLED) display, or other similar display technologies. In some aspects, display 458 may be touch-sensitive and may also function as an input device.

Input device 459 may include, for example, a keyboard, a mouse, a touch-sensitive display, a keypad, a microphone, or other similar input devices or any other input devices that may be used alone or together to provide a user with the capability to interact with the computing device 400.

Further, as shown as part of system 400, there is provided a local memory and/or an attached memory storage device 460, or a remote memory storage device, e.g., a database, accessible via a remote network connection for input to the system 400. The local or remote memory 460 may be configured for storing information 462, e.g., data, metadata, programs, etc.

Memory 450 of computer system 400, in one or more embodiments, stores one or more processing modules that include, for example, programmed instructions adapted to facilitate and/or assist with planning, predicting, and/or calculating cloud computing resources needed in the future, e.g., to handle cloud computing capacity planning. In one embodiment, one of the programmed processing modules stored at the associated memory 450 includes a data ingestion module 465 that provide instructions and logic for operating circuitry to access/read data for use by other modules.

In an embodiment, a Capacity Planning Module 470 is included in the system 400, e.g., in memory 450, and provides instructions and logic for operating circuitry to handle, facilitate, assist with, and/or contribute to planning, predicting, and/or calculating the cloud computing resources needed, for example, in the future, by for example a cloud computing provider. In an aspect, capacity Planning Module 470 employs instructions and logic for operating circuitry to plan, predict, and/or calculate needed cloud computing resources, including in an embodiment planning for, predicting, and/or calculating cloud computing infrastructure resources needed in the future, which in an aspect uses customer-specific data. In a further aspect, Capacity Planning Module 470 employs instructions and logic to operate circuitry to plan, predict, and/or calculate needed cloud computing resources using both infrastructure-related data and customer-specific data.

In one or more embodiments, Capacity Planning Module 470 leverages cognitive capabilities. A cognitive system (sometimes referred to as deep learning, deep thought, or deep question answering) is a form of artificial intelligence that uses machine learning and problem solving. A modern implementation of artificial intelligence (AI) is the IBM Watson cognitive technology. Models for scoring and ranking an answer can be trained on the basis of large sets of input data. The more algorithms that find the same answer independently, the more likely that answer is correct, resulting in an overall score or confidence level. Cognitive systems are generally known in the art. In an aspect, Capacity Planning Module 470 leverages cognitive capabilities by including machine learning (ML) models. A machine learning model module 475 and machine learning algorithm can be part of the Capacity Planning Module 470, or in an aspect machine learning modules and algorithms, for example pattern detection, regression analysis, and/or anomaly detection algorithms and programming to name just a few, can be part of a separate ML model module 485 within Memory 450 as shown in FIG. 4. Capacity Planning Module 470 can also include in an embodiment Natural Language Processing (NLP) module 480, which in an aspect can include natural language processing algorithms and programming, as well as data science algorithms and programming.

Memory 450 optionally includes a supervisory program having instructions for configuring the computing system 400 to call one or more of the program modules and invoke the operations of system 400. In an embodiment, such supervisory program provides application program interfaces (APIs) for running the Capacity Planning Module 470, including the various machine learning (ML) models for planning for, predicting, and/or calculating the amount of cloud computing resources that need to be reserved, e.g., for future use, including in an embodiment using customer-specific data, and in a further aspect additionally using infrastructure-related data. In an embodiment, application program interface (API) 495 is invoked in an embodiment to call Capacity Planning Module 470.

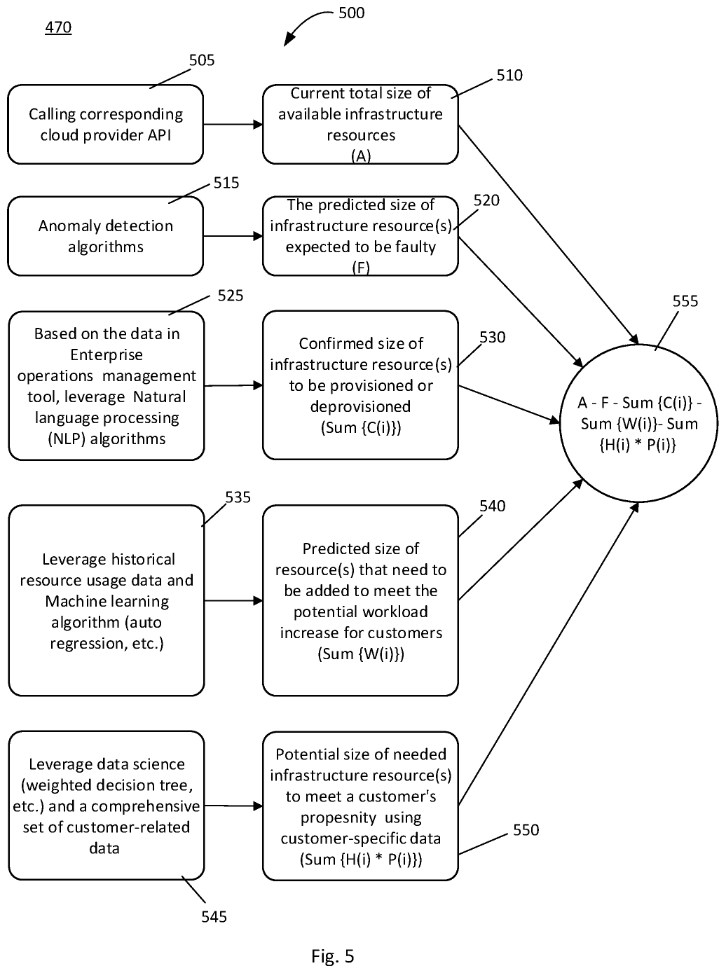

FIG. 5 illustrates an overview of an embodiment of Capacity Planning System 500 which in an aspect includes Capacity Planning Module (Engine) 470 of FIG. 4. Capacity Planning Module 470, also referred to as Capacity Planning Engine 470, in an embodiment employs instructions and logic for operating circuitry to perform and/or consider infrastructure-side capacity planning. In one or more aspects, Capacity Planning Module 470 includes one or more modules and/or functional units to calculate infrastructure-side computing resource needs, by: for example, calling cloud infrastructure API to get the current size of computing infrastructure resources available by the cloud computing resource provider (A); leveraging anomaly detection algorithms to predict the size or amount of infrastructure computing resources that are likely to be faulty (F); leverage natural language processing (NLP) algorithms and data in enterprise operations management tools to confirm the size or amount of infrastructure computing resources already provisioned or de-provisioned by customers (Sum{C(i)}); and/or leverage historical resource usage data and machine learning algorithms (e.g., auto regression, etc.) to predict the amount of resources needed to meet potential workload increase by customers (Sum{W(i)}).

In an aspect, Capacity Planning System 500, and Capacity Planning Module 470, in an aspect employs instructions and logic for operating circuitry to consider and analyze consumer-specific data, that in an embodiment leverages data science and machine learning (ML) algorithms (weighted decision tree, etc.) to predict and/or confirm customer plans to expand (increase) or contract (decrease) computing resource usage. In one or more aspects, Capacity Planning Module 470 includes one or more modules and/or functional units to calculate, predict, and/or confirm computing resource usage based upon leveraging data science and a set of consumer-related or consumer-specific data to predict and/or confirm the potential size and/or amount of resources needed to meet customer needs. In one or more embodiments, customer-specific data includes, for example: change/provisioning request data in Enterprise Operations Management tools (e.g., ServiceNow), which can confirm how much computing resources are reserved for a specific customer; social media data (Linkedin, Facebook, etc.) and customer call data to calculate customer's sentiment regarding and/or likelihood of provisioning new computing resources by leveraging sentimental analysis, Watson Speech to Text, Naïve Bayes classifier, etc.; Customer relationship management (CRM) data, Business Support systems (BSS) data, and/or similar customer data and leveraging machine learning (ML) and natural language processing (NLP) algorithms to predict the size or amount of infrastructure computing resources likely to be implemented immediately and more long-term (e.g., calculate long term value of customer); and/or other customer data, e.g., frequency of provision requests, type of customer (e.g., bank, etc.), customer requiring higher SLA, etc., which can be used to predict for example the urgency level for provisioning resources.

The potential size of infrastructure resources needed for customers based upon customer-specific data can be represented by Sum{H(i)*P(i)} where P(i) stands for a customer's propensity to expand infrastructure resource usage, and the possibility whether the cloud computing vendor needs to reserve resources for the customer. The value of P(i) in an aspect can be either a “1” or a “0”, where a “1” means a customer is likely to expand its resource usage, and a “0” means a customer is likely not to expand its cloud computing resources and the cloud computing vendor does not need to reserve any computing resources for the customer. H(i) in an embodiment stands for and represents the size of the infrastructure resources that the customer expresses it will likely need or provision. If the customer does not express or claim how much computing resources will be provisioned or needed, then H(i) in an embodiment can be estimated as the average computing resource size or amount provisioned in the past based upon historical provision requests, and in an aspect takes into account the amount of time since its last provisioning request.

Capacity Planning System 500 and/or Capacity Planning Module 470, in one or more embodiments provides quantitative analysis and calculation of computing resource capacity needs based upon both infrastructure-side data and consumer-specific data. In an embodiment, the calculation and/or prediction of computing resources needed (N) in the future can be represented by the equation: N=A−F−Sum{C(i)}−Sum{W(i)}−Sum{H(i)*P(i)}, where A represents current total size of resources, F represents faulty resources, Sum{C(i)} represents confirmed provisioned resources, Sum{W(i)} represents predicted size/amount of resources to be needed, and Sum{H(i)*P(i)} represents potential size/amount of resources to be needed based upon customer-specific data.

In one or more embodiments, turning to FIG. 5, the Capacity Planning System 500 and/or Capacity Planning Module 470, at 505 the cloud provider API is called and/or invoked to determine at 510 the total current size and/or amount of available computing resources, e.g. infrastructure resources, by the cloud computing provider. In an aspect, determining the total current size and/or amount of currently available cloud computing resources is performed on a resource-by-resource basis. That is, for example, in an aspect, the total amount of CPU resources currently available is computed separately from, for example, the total amount of RAM resources currently available. The total current size and/or amount of computing resources available is determined in appropriate units, and is represented as “A”.

The Capacity Planning System 500 and/or Module 470 at 515 calls or invokes anomaly detection algorithms to determine at 520 the predicted size and/or amount of resources that are likely to be faulty and/or otherwise not work properly. In an aspect, determining the predicted size and/or amount of cloud computing resources likely to be faulty is performed on a resource-by-resource basis. That is, for example, in an aspect, the amount of CPU resources expected or predicted to be faulty is computed separately from, for example, the total amount of RAM resources expected or predicted to be faulty. The predicted size and/or amount of computing resources expected to be faulty is determined in appropriate units for the particular resource, and is represented as “F”.

The Capacity Planning System 500 and/or Module 470 at 525 calls or invokes natural language processing (NLP) algorithms, for example auto regression, etc. and uses data in and from enterprise operations management tools at 530 to determine the confirmed size and/or amount of computing resources to be provisioned and/or released (de-commissioned). In an aspect, determining the confirmed size and/or amount of cloud computing resources to be provisioned and/or released is performed on a resource-by-resource basis. That is, for example, in an aspect, the size and/or amount of CPU resources confirmed to be commissioned and/or provisioned or released/decommissioned is computed separately from, for example, the size and/or amount of RAM resources confirmed to be commissioned/provisioned and/or released/decommissioned. The confirmed size and/or amount of computing resources confirmed to be commissioned/provisioned and/or released/decommissioned is expressed in appropriate units for the particular resource, and is represented as Sum{C(i)}. In one or more aspects, the confirmed size and/or amount of computing resources subject to provisioning requests by customers are summed. In an aspect, the confirmed size and/or amount of computing resources confirmed to be provisioned and/or released can be performed for all customers, or a subset of customers, for example for premium customers, large computing resource customers, and/or the fastest growing computing resource customers.

The Capacity Planning System 500 and/or Module 470 at 535 calls or invokes natural machine learning (ml) algorithms, for example from machine learning module 475 or 485, and uses or leverages historical resource usage data to determine and/or predict at 540 the workload size and/or amount of computing resources needed to meet potential workload increases for customers. In an aspect, determining and/or predicting the workload size and/or amount of cloud computing resources needed to meet potential workload increases is performed on a resource-by-resource basis. That is, for example, in an aspect, predicting the size and/or amount of CPU resources needed to meet potential workload increases is computed separately from, for example, predicting the size and/or amount of RAM resources needed to meet potential workload increases. The work load size and/or amount of computing resources to meet potential workload increases is expressed in appropriate units for the particular resource, and is represented as Sum{W(i)}.

In an aspect, determining and/or predicting the workload size and/or amount of computing resources needed to meet potential workload increases for customers are summed. In one or more embodiments, determining the workload size and/or amount of computing resources needed to meet potential workload increases can be performed for all customers, or a subset of customers, for example for premium customers, large computing resource customers, fastest growing computing resource customers, and/or high value computing resource customers. In an embodiment, on a resource basis, the confirmed size and/or amount of confirmed resources to be provisioned and/or released (e.g., Sum{C(i)}) can be subtracted or excluded from the workload size or amount of resources needed to meet potential workload increases (e.g., Sum{W(i)}). In this manner, the calculated and/or predicted amount of needed resources to be added to a system takes into consideration the confirmed size and/or amount of a particular resource that is already being commissioned (or released) when projecting and/or predicting the size and/or amount of resources required to meet potential future needs. In a further embodiment, on a customer basis, the workload size and/or amount of a particular computing resource, e.g., RAM, confirmed to be provisioned and/or released (e.g., Sum{C(i)}) can be subtracted or excluded from the predicted workload size or amount of a particular resource needed to meet potential workload increases (e.g., Sum{W(i)}). In an aspect, Sum{W(i)} should be computed in a manner to increase accuracy by considering the confirmed size and/or amount of a particular computing resource already provisioned when calculating the potential workload increase for that particular computer resource by that customer.

In an aspect, Capacity Planning System 500, and Capacity Planning Module 470, in an aspect at 545 calls or invokes various consumer-specific data, that in an embodiment leverages data science (weighted decision tree, etc.), to determine, predict, and/or confirm at 550 customer plans to expand (increase) or contract (decrease) computing resource usage. In an aspect, determining, predicting, and/or confirming the potential size and/or amount of needed cloud computing resources that a customer plans to increase or decrease, by using customer-specific data, is performed on a resource-by-resource basis. That is, for example, in an aspect, determining, predicting, and/or confirming using customer-specific data the potential amount of needed CPU resources that a customer plans to increase or decrease is computed separately from, for example, determining, predicting, and/or confirming the potential amount of needed RAM resources that a customer plans or anticipates to increase or decrease. The potential size and/or amount of needed computing resources that a customer plans or anticipates increasing or decreasing that is determined, confirmed, and/or predicted using customer-specific data is expressed in appropriate units for the particular resource, and is represented as Sum{H(i)*P(i)}.

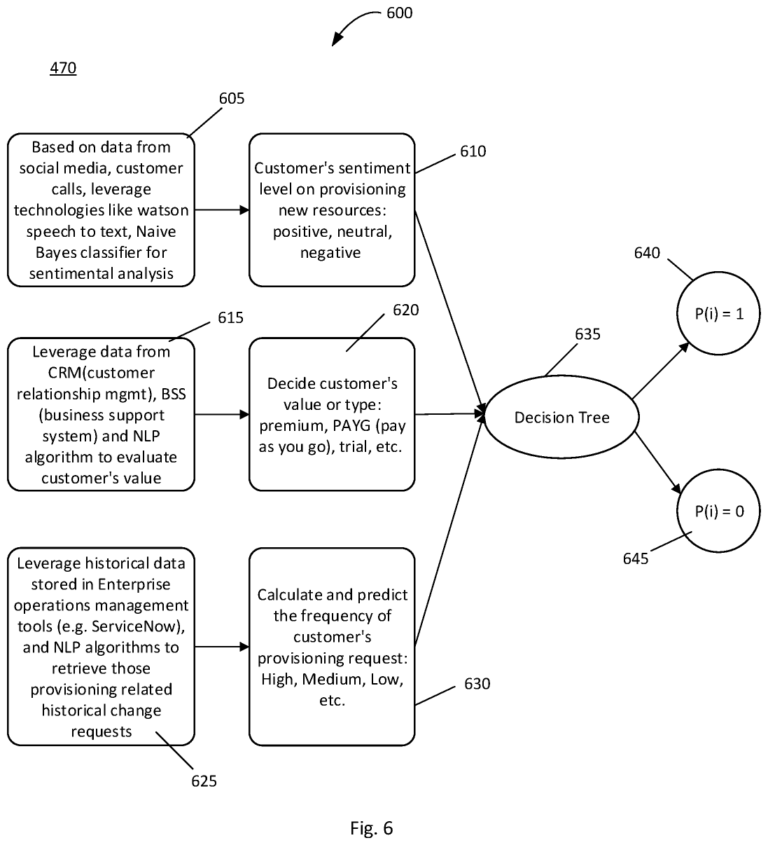

In one or more embodiments, the potential size and/or amount of needed computing resources planed or anticipated H(i)*P(i)} is summed on a customer basis. In one or more embodiments, determining the potential size and/or amount of needed computing resources to meet customer expectations and/or plans can be performed for all customers, or a subset of customers, for example for premium customers, large computing resource customers, fastest growing computing resource customers, and/or high value computing resource customers. Further details on calculating the potential size and/or amount of needed computing resources that a customer plans on increasing or decreasing using customer-specific data, also referred to as a customer's propensity to increase or expand their computing resources, is described in more detail in connection with FIG. 6.

In an aspect, determining, predicting, and/or confirming the potential size and/or amount of needed computing resources using customer-specific data can be calculated for all customers, or a subset of customers, for example for premium customers, large computing resource customers, fastest growing computing resource customers, and/or high value computing resource customers. In an embodiment, on a resource basis, the size and/or amount of confirmed resources to be provisioned and/or released (e.g., Sum{C(i)}) and the predicted size or amount of computing resources needed to meet potential workload increases (e.g., Sum{W(i)}) can be subtracted or excluded from the potential size and/or amount of needed cloud computing resources that a customer plans to increase or decrease that was calculated using customer-specific data (Sum{H(i)*P(i)}). In this manner, the potential amount of needed computing resources that was calculated using customer-specific data takes into consideration the size and/or amount of a particular resource that is already being commissioned (or released) as well as the size and/or amount of computing resources needed to meet potential work load increases. In a further embodiment, on a customer basis, the size and/or amount of a particular computing resource (e.g., RAM) confirmed to be provisioned and/or released (e.g., Sum{C(i)}) and the size or amount of the particular resource (e.g., RAM) determined to meet potential workload increases (e.g., Sum{W(i)}) can be subtracted from or excluded from the potential size and/or amount of a needed particular computing resource that was calculated using customer-specific data.

The values calculated at 510, 520, 530, 540 and/or 550 are used at 555 to predict whether to add cloud computing resources to a cloud computing system, and in an embodiment to calculate the amount of computing resources (N), e.g., cloud computing infrastructure resources, available to meet future needs. In one or more embodiments, the value A (the current total amount of computing resource(s)) calculated at 510; the value F (the predicted size of computing resources expected to be faulty) calculated at 520; the value Sum{C(i)} (confirmed size of computing resources to be provisioned) calculated at 530; the value Sum{W(i)} (the workload size of the potential workload increase) calculated at 540; and/or the value of Sum{H(i)*P(i)} (the potential size of needed computing resources determined through customer-specific data) calculated at 550 are used at 555 to predict whether to add cloud computing resources to a cloud computing system. In an embodiment, the amount of cloud computing resources predicted to meet present and/or future cloud computing needs (N) can be calculated using the formula N=A−F−Sum{C(i)}−Sum{W(i)}−Sum{H(i)*P(i)}.

The calculation of “N” at 555 can be performed on a resource-by-resource basis. For example, in an aspect, the amount of CPU resources available as calculated at 555 using the formula can and preferably is computed separately from, for example, the total amount of RAM resources available. In a further aspect, the calculation of “N” at 555 can be performed on a customer-by customer basis. For example the calculation of computing resources available can be computed for customer A, followed by customer B, etc. and the resulting values can be summed for all the customers, or one or more groups of the customers, depending upon the level of granularity and/or accuracy desired. For example, the calculation of Sum{W(i)} at 540 can be performed on a customer-by-customer basis for a subgroup of customers, for example the group of customers whose use of computing resources is growing the fastest and/or the group of customers whose use of computing resources is the largest. The calculation of Sum{H(i)*P(i)} at 550 meanwhile also can be performed on a customer-by-customer basis for a subgroup of customers, and the subgroup of customers can be the same as or different than the subgroup of customers for which Sum{W(i)} is calculated at 540.

The output at 555 is preferably used as an indication of computing resources needed to meet present and/or future needs. The output at 555 is preferably expressed on a computing resource basis, e.g., a cloud computing infrastructure resource need, and can be used by a cloud computing provider to adjust and/or modify its computing infrastructure. Based upon the output or result at 555, a negative value would mean that a cloud vendor should and/or needs to add more resources, a slightly positive value, e.g., a little higher than 0, would be a warning that more of a particular resource should and/or needs to be added, and if a sufficiently high positive value, the vendor should not need to add the particular resource. As a best practice it would be preferred to add more of the particular resource than expressed by the value output at 555 as a buffer.

Whether the output or result at 555 indicates to add a particular resource can, in an embodiment, be expressed as a percentage of the current total of that particular resource that is available. For example, if the value output at 555 is a high number but is a relatively low percentage of the total current value of that particular resource used by/in the cloud computing system, then such low percentage can act as a warning and indicate that more of that particular computing infrastructure resource should be added by the cloud computing vendor. In one or more embodiments, the output N can be represented as a percentage ((A−F−Sum{C(i)}−Sum{W(i)}−Sum{H(i)*P(i)})/A*100). In this manner, a negative percentage output at 555 would indicate to add more of a resource (e.g., a particular infrastructure resource), a low positive percentage output (e.g., less than 10%) at 555 would also indicate to add more of a resource (e.g., a particular infrastructure resource), and a high percentage output at 555 would indicate that a resource (e.g., a particular infrastructure resource) does not need to be added.

Turning to more specifics of using customer specific data to predict and/or confirm at 550 customer plans to expand (increase) or contract (decrease) computing resource usage. The size and/or amount that a customer plans to expand or contract its computing resource usage as determined using customer-specific data is expressed and/or represented by the formula Sum{H(i)*P(i)} where H(i) represents the size and/or amount that the customer claims or expresses that it intends to expand (or decrease) its computing resources as provided in or by the customer-specific data (e.g., customer calls with vendors, messages posted by customers in social media, etc. If the customer does not express a size or an amount by which it intends or plans to increase its computing resources, then H(i) in an embodiment will be estimated as an average resource size calculated using historical provisioning records and/or requests, preferably over a time period. For example the time period over which the historical records can be averaged can be a year, a quarter, and/or a month, although other time periods for averaging the historical records can be used. In an aspect, when calculating H(i), the size and/or amount to be provisioned can take into account the last time that the customer provisioned that particular resource. That is, the system and/or method can adjust the value for H(i) when calculated as an historical average to take into account how long the customer last requested or provisioned that particular resource. In this regard if the historical average is based on a per month time period, and the customer has not requested and/or provisioned that particular resource for two months, then H(i) can be adjusted to account for the two month period since last provisioning that particular computing resource.

In an aspect, if the customer does not express a size or an amount by which it intends or plans to increase its computing resources, then H(i) in an embodiment can be estimated as an adjusted average resource size calculated using historical provisioning records and/or requests, preferably over a time period. In this example of an adjusted average resource size, H(i) can take into account the tendency of provisioning requests to increase or decrease over time, and/or can take into account where a customer increases (or decreases) its computing resources needs based upon seasonal events and/or the calendar. For example, a customer may have busy periods during the year where it tends to increase its computing resource needs more than other periods during the year.

P(i) in 550 represents a customer's propensity to expand their computing infrastructure resource usage, and the possibility of whether a cloud computing vendor will need to reserve infrastructure resources for the customer. The value of P(i) in one or more embodiments will be either a “1” or a “0”, where a “1” means a customer will expand resource usage so additional cloud computing resources should be brought online, and a “0” means a customer won't expand resource usage so the cloud computing vendor will not need to reserve computing resources.

FIG. 6 provides further explanation of how in an example to calculate P(i), a customer's propensity to expand their infrastructure usage using customer-specific data. A system 600 for calculating a customer's propensity to expand their infrastructure usage using customer-specific data is shown in FIG. 6, where Capacity Planning Module 470 is called and/or invoked. At 605 customer-specific data such as social media data from Linkedin, Facebook, Twitter, etc. and/or customer call data are obtained and/or received and technologies such as for example Watson Speech to Text, Naïve Bayes Classifier, and other technologies are leveraged to determine at 610 a customer's likelihood, inclination, and/or sentiment in expanding or provisioning new computing resources is positive, neutral, or negative. Basically, at 610, based upon reviewing and/or analyzing social media data, customer call data, and/or other media specific to a customer, it is determined and parsed from such data whether or not there are indications that a customer will need to expand its computing resources. For example, discussions of an acquisition might indicate growth and a need to increase computing resources.

At 615 customer-specific data such as customer relationship management (CRM) data, business support system (BSS) data, and/or other customer-specific data is obtained and received, and technologies such as Natural Language Processing (NLP) algorithms are used to evaluate at 620 a customer's value and/or type. For example, it can be determined at 620 whether a customer is a premium customer, a pay as you go (PayG) customer, a trial customer, etc. At 625 customer-specific data such as historical data stored in enterprise management tools (e.g., ServiceNow) are obtained and/or retrieved using natural language processing (NLP) algorithms to in an example retrieve historical cloud resource provisioning change requests to calculate and/or predict at 630 the frequency by which a customer provisions computing resources. At 630 the frequency that a customer submits provisioning requests can be expressed as high, medium, or low, although other manners of expressing the frequency at which a customer requests computing resources is contemplated.

The decisions, determinations, calculations, and/or outputs from 610, 620, and/or 630 in an embodiment are feed into a decision tree at 635. That is, the customer's sentiment and/or inclination level of provisioning computing resources as determined at 610, the customer type as determined at 620, and the customer's frequency of requesting and/or provisioning computing resources as determined at 630 are fed to a decision tree at 635. The decision tree at 635 can be a weighted decision tree and can weigh the values and outputs from 610, 620, and/or 630 differently, and in an aspect can weigh values progressively or linearly. The decision tree at 635 can be programmed and tailored using machine learning to increase its accuracy over time. The output at 635 can represent a customer's propensity to expand their computing resources as determined by customer-specific data. The output of decision tree 635, e.g., the value of P(i), can be a “1” as shown at 640 indicating that the potential size increase from customer-specific data Sum{H(i)} is used or can be a “0” as shown at 645 indicating that the potential size increase confirmed using customer-specific data Sum{H(i)} is not used. In one or more embodiments the determination at 635 can act as a trigger as to whether to apply (subtract) to the calculation and/or prediction of needed cloud computing resources the customer's propensity to expand their resources as determined by customer-specific data.

In one or more embodiments, other customer-specific data, e.g., customer type (bank, etc.) and customer requiring high SLA, can optionally be used, using for example Watson PI, and decision tree, to decide if the expansion of computing resources is urgent or not from a customer's perspective. In many instances the disclosure refers to increasing and/or expanding computing resources, however, it should be appreciated that such calculations and/or determinations not only apply to increases or expansions but also to decreases or contractions in computing resources, and in an embodiment can be represented as negative values in the determinations and/or calculations.

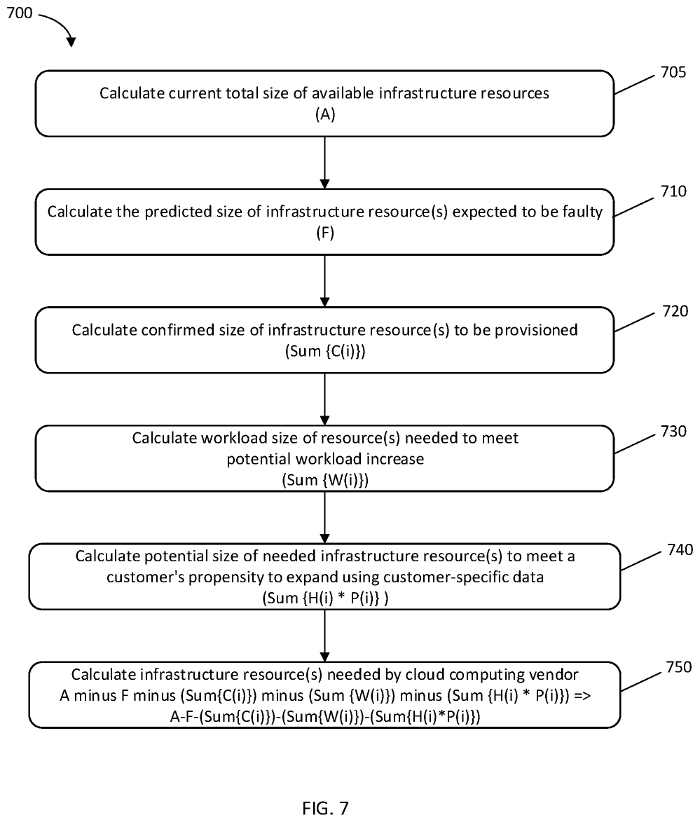

FIG. 7 is an exemplary flowchart in accordance with an embodiment illustrating and describing a method 700 of planning, predicting, and/or calculating cloud computing capacity requirements or needs, including in an aspect using customer-specific data. While the method 700 is described for the sake of convenience and not with an intent of limiting the disclosure as comprising a series and/or a number of steps, it is to be understood that the process does not need to be performed as a series of steps and/or the steps do not need to be performed in the order shown and described with respect to FIG. 7, but the process may be integrated and/or one or more steps may be performed together, simultaneously, or the steps may be performed in the order disclosed or in an alternate order.

In one or more aspects, the method 700 includes at 705 determining and/or calculating the current total size and/or amount of available cloud computing resource(s), e.g., cloud computing infrastructure resource(s). The current total size and/or amount of available cloud computing resources is expressed as value A. In an embodiment determining and/or calculating the current total size and/or amount of available cloud computing resources is performed by calling the cloud computing vendor API. At 710, the predicted size of cloud computing resource(s), e.g., cloud computing infrastructure resource(s), expected to be faulty is determined and/or computed. The Predicted size and/or amount of computing resource(s) expected to be faulty is expressed as value F. In an embodiment, determining and/or calculating the predicted size and/or amount of computing resources expected to be faulty is calculated by calling anomaly detect algorithms.

At 720 the confirmed size and/or amount of computing resource(s) to be provisioned, e.g., pending provisioning requests, is determined and/or calculated. The confirmed size and/or amount of cloud computing resource(s) confirmed to be subject to provisioning requests is expressed as value Sum{C(i)}, and in an embodiment is calculated on a customer and resource basis. All customers or a subgroup of customers can be used to determine and/or calculate Sum{C(i)}. In an embodiment, determining and/or calculating the confirmed size and/or amount of computing resource(s) confirmed to already be subject to provisioning requests, e.g., Sum{C(i)}, is determined and/or calculated using natural language processing (NLP) algorithms based upon data in enterprise operations management tools. At 730 the workload size and/or amount of computing resource(s) that are expected to meet potential workload increases is determined and/or calculated. The workload size and/or amount of cloud computing resource(s) expected to meet potential workload increases is expressed as value Sum{W(i)}, and in an embodiment can be calculated on a customer and resource basis. All customers or a subgroup of customers can be used to determine and/or calculate Sum{W(i)}. In an embodiment the workload size and/or amount of computing resource(s) to meet potential workload increases is calculated by monitoring each customer's environment workload changes and leverage historic resource usage data and applying machine learning (ML) algorithms.

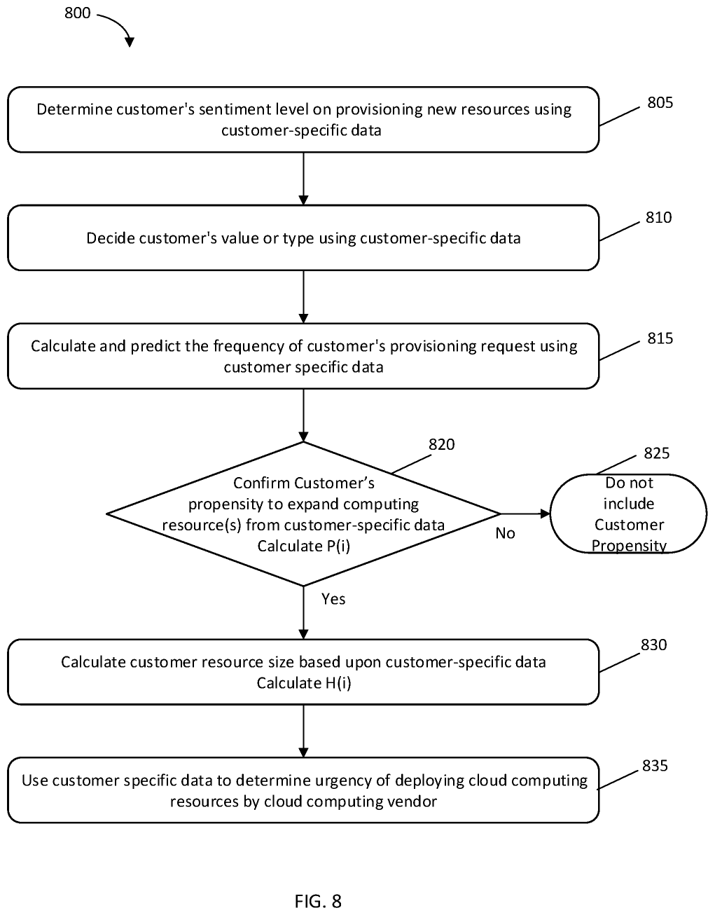

At 740 the potential size and/or amount that a customer has a propensity to increase their cloud computing resource(s) is calculated using customer-specific data. The potential size and/or amount that a customer has a propensity to increase their computing resources is expressed as Sum{H(i)*P(i)}. Calculating the potential size and/or amount that a customer has a propensity to increase their computing resource(s) is calculated leveraging data science and sets of consumer-related data and is discussed in more detail in connection with the flowchart in FIG. 8 and the method 800 of determining and/or calculating a customer's propensity to increase (or decrease) its cloud computing resources, e.g., its cloud computing infrastructure resources needs.

At 750, the computing resource needs of the cloud computing vendor are predicted and/or calculated. In an aspect the predicted computing resource needs (N) are calculated according to the formula N=“A” minus/subtract “F” minus/subtract “Sum{C(i)}” minus/subtract “Sum{W(i)} minus/subtract “Sum{H(i)*P(i)}” (i.e., N=A−F−Sum{C(i)}−Sum{W(i)}−Sum{H(i)*P(i)}). In this regards the values calculated in 705, 710, 720, 730, and/or 740 can be used to predict and/or calculate the cloud computing resource needs. In an aspect, the cloud computing resource needs (N) can be calculated on a resource-by-resource basis. The resource values calculated in 720, 730, and/or 740 can be calculated for all customers, or for subgroups of customers, where the subgroup of customers can be the same or different for each of the resource calculations in 720, 730, and/or 740. While the calculation of (N) is shown at 750 as being performed after the various calculations are performed at 705, 710, 720, 730, and/or 740, it can be appreciated that the calculation of (N) can be performed as the various calculations and values are arrived at in 710, 720, 730, and/or 740. In other words, the subtractions from the calculation of the current total size of computing resources (A) can be performed in any order. While the calculation of N at 750 has been shown based upon the determinations at 705, 710, 720, 730, and/or 740, it can be appreciated that only one or more of the determinations at 705, 710, 720, 730, and/or 740 can be utilized in the calculation/determination at 750, and in embodiments, additional and/or alternative determinations and/or calculations can be included at 750.

The calculation at 750 preferably is used as an indication of computing resources needed to meet present and/or future needs. The output at 750 is preferably expressed on a computing resource basis, e.g., a cloud computing infrastructure resource need, and can be used by a cloud computing provider to adjust and/or modify its computing infrastructure. Based upon the output or result at 750, a negative value would mean that a cloud vendor should and/or needs to add more resources, a slightly positive value, e.g., a little higher than 0, would be a warning that more of a particular resource should and/or needs to be added, and if a sufficiently high positive value, the vendor should not need to add the particular resource. As a best practice it would be preferred to add more of the particular resource than expressed by the value output at 750 as a buffer.

Whether the output or result at 750 indicates to add a particular resource can, in an embodiment, be expressed as a percentage of the current total of that particular resource that is available. For example, if the value or result at 750 is a high number but is a relatively low percentage of the current total value of that particular resource used by/in the cloud computing system, then such low percentage can act as a warning and indicate that more of that particular computing infrastructure resource should be added by the cloud computing vendor. In one or more embodiments, the output N can be represented as a percentage (N=((A−F−Sum{C(i)}−Sum{W(i)}−Sum{H(i)*P(i)})/A)*100)). In this manner, a negative percentage output or result at 750 would indicate to add more of a resource (e.g., a particular infrastructure resource), a low positive percentage output (e.g., less than 10%) at 750 would also indicate to add more of a resource (e.g., a particular infrastructure resource), and a high percentage output at 750 would indicate that a resource (e.g., a particular infrastructure resource) does not need to be added.

FIG. 8 is an exemplary flowchart in accordance with another embodiment illustrating and describing a method 800 of calculating, determining and/or confirming, using customer-specific data, a customer's propensity to increase their cloud computing resource(s). While the method 800 is described for the sake of convenience and not with an intent of limiting the disclosure as comprising a series and/or a number of steps, it is to be understood that the process does not need to be performed as a series of steps and/or the steps do not need to be performed in the order shown and described with respect to FIG. 8, but the process may be integrated and/or one or more steps may be performed together, simultaneously, or the steps may be performed in the order disclosed or in an alternate order.

Method 800 in an embodiment is directed to determining and/or calculating a customer's propensity to increase (or decrease) their cloud computing resource(s), and the potential size of the needed computing resources to meet that customer's propensity, which can be expressed as Sum{H(i)*P(i)}. At 805, a customer's sentiment level on provisioning new computing resources is determined. In one or more embodiments, at 805 social media data (Linkedin, Facebook, Twitter, etc.) can be analyzed, using for example Watson Speech to Text, Naïve Bayes classifier, etc., to obtain information useful in determining the likelihood that a customer will or is planning on expanding their computing resources. Customer calls in an embodiment are also reviewed and/or analyzed to determine a customer's sentiment level on expanding their computing resources. Other customer-specific data in an embodiment can be reviewed and/or analyzed at 805 to provide input into determining a customer's propensity to increase their computing resources.

At 810, a customer's value and/or type is determined. In an aspect, at 810, information as to the level or value of a customer is determined. For example, is the customer a premium customer, a fast growing customer, and/or a customer who uses a large amount of computing resources can be determined at 810. At 810 customer relationship management (CRM) and/or business support system (BSS) data is reviewed and/or analyzed using for example machine learning (ML) and natural language processing algorithms. At 810, in an embodiment, customer-specific data is reviewed and/or analyzed to determine the value of the customer to the cloud computing vendor. In an aspect, the value of the customer can be categorized into value levels, for example, high, medium, low, or other value levels.

At 815, the frequency of a customer's request to provision additional computing resources is predicted using customer-specific data. In one or more embodiments, at 815, change and/or provisioning request data (indicating requests for computing resources) in enterprise operations management tools (e.g., ServiceNow) can confirm the size and/or amount of computing resources that have been reserved in the past, including in an aspect pending provisioning requests. In an aspect, natural language processing (NLP) algorithms can be used to review, parse, and/or analyze the data for pertinent information. The review and/or analysis can categorize the frequency at which a customer provisions additional resources for example into high, medium, or low, or other categorizes.

The information and data obtained at 805, 810, and/or 815 can be used at 820 to determine and/or confirm a customer's propensity to expand its computing resources. It can be appreciated that the data and/or information (output) from 805, 810, and/or 815 can be obtained, determined, and/or derived on a customer-by-customer basis, and/or on a computing resource-by-resource basis. In an embodiment, the determination at 820 can be determined with respect to a time frame, e.g., the next 3 months, although other time frames are contemplated. In one or more aspects, P(i) is calculated at 820 using the information/data obtained at one or more of 805, 810, and/or 815. It can be appreciated that other customer-specific data can be used at 820 to determine whether a customer is likely to expand its computing resources. The data and information obtained at 805, 810, and/or 815 can be feed into a decision tree at 820, e.g., a weighted decision tree, where it can be determined, predicted, and/or confirmed whether or not a customer is likely to increase (or decrease) its computing resources.

In an embodiment, the value output by the decision tree at 820, e.g., the value of P(i), is zero, indicating that the customer is not inclined to increase computing resources. If at 820 it is determined and/or confirmed that a customer is not likely to expand its computing resources (820: No), e.g., P(i) is zero, then at 825 no further information or value is provided for the calculation to determine computing resource needs for that customer. In this regard, since it has been determined that a client is not likely to expand its computing resources (e.g., P(i) is zero) in for example the near future, no computing resources need to be reserved and no computing resource size or amount needs to be calculated (e.g., Sum{H(i)*P(i)} is zero) when determining computing resource capacity planning. On the other hand, if at 820 it is determined based upon the consumer-specific data that a customer is likely to expand its computing resources (820: Yes), e.g., P(i) is 1, then process 800 continues to 830. While in embodiments the customer's propensity to expand its computing resources (e.g., P(i) has been expressed as either a value of “1” or “0”, the output at 820 can be represented as a value between “0” and “1”, e.g., a decimal number, and/or set forth in levels between “0” and “1”, which in an aspect can represent probability factors, e.g., 0.1, 0.2, 0.3, etc., that a customer will expand its computing resources.

At 830, the size and/or amount of computing resources to calculate for the customer based upon the information obtained from the customer-specific data is calculated. It can be appreciated that at 830 the calculation can be performed on a customer-by-customer basis, and/or on a computing resource-by-resource basis. In one or more embodiments H(i) is calculated and/or determined at 830 where H(i) represents the size and/or amount of computing resource(s) that a customer is likely to increase (or decrease). In an embodiment, the size and/or amount that a customer is likely to expand its computing resources at 830 is the size and/or amount that the customer claims, indicates, and/or expresses, that it is going to expand its computing resources. In this manner the customer-specific data that is reviewed and/or analyzed in instances will express, claim, and/or indicate the size and/or amount of computing resources the customer intends to provision. In another embodiment, the size and/or amount of computing resources a customer is likely to expand is determined at 830 based upon historical data, where historical provisioning requests can be used to calculate an average provisioned resource size, or a weighted average provisioned size that takes into account historical progressions (increases and/or decreases) and/or seasonal changes. In one or more embodiments, the value of Sum{H(i)*P(i)} is calculated, e.g., the potential size and/or amount of needed computing resources to meet a customer's propensity to expand its computing resources based upon customer-specific data, and in an aspect, the calculation is performed on a resource-by-resource basis and/or a customer-by-customer basis.

At 835, customer-specific data can be used to determine the urgency of adding cloud computing resources. The type of customer (e.g., bank, etc.), the level of service (customer requiring higher SLA), and the frequency and/or size of past provisioning requests can be used to determine the urgency of adding computing resources. For example, in an embodiment, customer specific data can be leveraged to determine and/or account for the time frame and/or urgency to add computing resources.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor, functional units of a processor, or computer implemented system, and logic integrated with and/or executable by the system, processor, or functional units, the logic being configured to perform one or more of the process steps cited herein. What is meant by integrated with is that in an embodiment the functional unit or processor has logic embedded therewith as hardware logic, such as an application specific integrated circuit (ASIC), a field programmable gate array (FPGA), etc. By executable by the functional unit or processor, what is meant is that the logic in an embodiment is hardware logic; software logic such as firmware, part of an operating system, part of an application program; etc., or some combination of hardware or software logic that is accessible by the functional unit or processor and configured to cause the functional unit or processor to perform some functionality upon execution by the functional unit or processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above. If will be further appreciated that embodiments of the present invention may be provided in the form of a service deployed on behalf of a customer to offer a service on demand.

The terminology used herein is for the purpose of describing particular embodiments only and is not intended to be limiting of the invention. Unless otherwise specifically defined herein, all terms are to be given their broadest possible interpretation including meanings implied from the specification as well as meanings understood by those skilled in the art and/or as defined in dictionaries, treatises, etc. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment and terminology was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method of predicting cloud computing resources to add to a cloud computing system comprising:
determining a total current size of available computing resources;
determining a predicted size of computing resources that are expected to be faulty;
determining a confirmed size of computing resources already provisioned;
determining a potential size of needed computing resources based upon analysis of customer-specific data; and
predicting cloud computing resources needed to be added to the cloud computing system comprises using the total current size of available computing resources; the predicted size of computing resources that are expected to be faulty; the confirmed size of computing resources already provisioned; and the potential size of needed computing resources based upon analysis of customer-specific data.

2. The computer-implemented method according to claim 1, further comprising determining a workload size of computing resources to meet potential workload increases in computing resources, and predicting the cloud computing resources needed to be added to the cloud computing system comprises using the workload size of computing resources to meet potential workload increases in computing resources.

3. The computer-implemented method according to claim 1, wherein determining the potential size of needed computing resources based upon analysis of customer-specific data comprises:
determining a customer's sentiment level on provisioning new computing resources using customer specific data.

4. The computer-implemented method according to claim 3, wherein determining a customer's sentiment level on provisioning new computing resources comprises reviewing at least one of a group consisting of: customer social media data, customer call data, and combinations thereof.

5. The computer-implemented method according to claim 4, wherein reviewing at least one of a group consisting of: customer social media data, customer call data, and combinations thereof comprises using at least one of a group consisting of machine learning algorithms, natural language processing algorithms, data science algorithms, and combinations thereof.

6. The computer-implemented method according to claim 1, wherein determining the potential size of needed computing resources based upon analysis of customer-specific data comprises:
determining a customer's value using customer-specific data, wherein determining a customer's value comprises reviewing at least one of the group consisting of customer relationship management data, business support system data, and combinations thereof.

7. The computer-implemented method according to claim 1, wherein determining the potential size of needed computing resources based upon analysis of customer-specific data comprises:
calculating a frequency of a customer's provisioning requests, wherein calculating a frequency of a customer's provisioning requests comprises reviewing historical data using enterprise operations management tools.

8. A computer-implemented method according to claim 1, wherein determining the potential size of needed computing resources based upon analysis of customer-specific data comprises:
determining a customer's sentiment level on provisioning new computing resources using customer specific data, wherein determining a customer's sentiment level on provisioning new computing resources comprises reviewing at least one of a group consisting of: customer social media data, customer call data, and combinations thereof;
determining a customer's value using customer-specific data, wherein determining a customer's value comprises reviewing at least one of the group consisting of customer relationship management data, business support system data, and combinations thereof; and
calculating a frequency of a customer's provisioning requests, wherein calculating the frequency of a customer's provisioning requests comprises reviewing historical data using enterprise operations management tools.

9. The computer-implemented method according to claim 8, wherein determining the potential size of needed computing resources based upon analysis of customer-specific data further comprising inputting into a decision tree at least one of a group consisting of the customer's sentiment level on provisioning new computing resources; the customer's value; and the frequency of a customer's provisioning requests.

10. The computer-implemented method according to claim 8, wherein determining the potential size of needed computing resources based upon analysis of customer-specific data is performed on a customer-by-customer basis.

11. The computer-implemented method according to claim 1, wherein predicting the cloud computing resources needed to be added to a cloud computing system is performed on a computing resource-by-resource basis.

12. The computer-implemented method according to claim 1, wherein the computing resources comprise at least one of a group consisting of: CPU, RAM, storage, servers, BareMetal servers, Network bandwidth, IP Addresses, Network Interface Cards (NICs), Power, and combinations thereof.

13. The computer-implemented method according to claim 1, wherein determining the potential size of needed computing resources based upon analysis of customer-specific data comprises determining the propensity of a customer to increase or decrease its cloud computing needs based upon analysis of customer-specific data and determining the size of the computing resource increase or decrease, wherein determining the size of the computing resource increase or decrease comprises using at least one of a group consisting of: a size of computing resources expressed by the customer, an average size of computing resources based upon historical usage by the customer, a weighted average of computing resources that takes into account trends in historical usage by the customer, a seasonally weighted average of computing resources that takes into account calendar year based changes by the customer, and combinations thereof.

14. A non-transitory computer readable medium comprising instructions that, when executed by at least one hardware processor, configure the at least one hardware processor to:
determine the total current size of available computing resources;
determine the potential size of needed computing resource based upon analysis of customer-specific data; and
predict the cloud computing resources needs to be added to a cloud computing system using the total current size of available computing resources and the potential size of needed computing resources based upon analysis of customer-specific data,
wherein determining the potential size of needed computing resources based upon analysis of customer-specific data comprises instructions that, when executed by at least one hardware processor, configure the at least one hardware processor to: perform at least one of a group consisting of:
determine a customer's sentiment level on provisioning new computing resources using customer-specific data, wherein determining a customer's sentiment level on provisioning new computing resources comprises reviewing at least one of a group consisting of: customer social media data, customer call data, and combinations thereof;
determine a customer's value using customer-specific data, wherein determining a customer's value comprises reviewing at least one of the group consisting of customer relationship management data, business support system data, and combinations thereof; and
calculate a frequency of a customer's provisioning requests, wherein calculating the frequency of a customer's provisioning requests comprises reviewing historical data using enterprise operations management tools.

15. The non-transitory computer readable medium according to claim 14, further comprising instructions that, when executed by at least one hardware processor, configure the at least one hardware processor to:
determine a predicted size of computing resources that are expected to be faulty;
determine a confirmed size of computing resources already provisioned;
determine a workload size of computing resources to meet potential workload increases in computing resources,
wherein predicting the cloud computing resources needed to be added to the cloud computing system further comprises instructions that, when executed by at least one hardware processor, configure the at least one hardware processor to use:
the predicted size of computing resources that are expected to be faulty;
the confirmed size of computing resources already provisioned; and
the workload size of computing resources to meet potential workload increases in computing resources.

16. The non-transitory computer readable medium according to claim 14, further comprising instructions that, when executed by at least one hardware processor, configure the at least one hardware processor to input into a decision tree at least one of a group consisting of the customer's sentiment level on provisioning new computing resources; the customer's value; and the frequency of a customer's provisioning requests to determine the potential size of needed computing resources based upon analysis of customer-specific data.

17. The non-transitory computer readable medium according to claim 14, wherein determining the potential size of needed computing resources based upon analysis of customer-specific data is performed on a customer-by-customer basis, and on a resource-by-resource basis.

18. The non-transitory computer readable medium according to claim 14, wherein determining the potential size of needed computing resources based upon analysis of customer-specific data comprises instructions that, when executed by at least one hardware processor, configure the at least one hardware processor to determine the propensity of a customer to increase or decrease its cloud computing needs based upon analysis of customer-specific data and to determine the size of the computing resource increase or decrease, wherein determining the size of the computing resource increase or decrease comprises instructions that, when executed by at least one hardware processor, configure the at least one hardware processor to use at least one of a group consisting of: a size of computing resources expressed by the customer, an average size of computing resources based upon historical usage by the customer, a weighted average of computing resources that takes into account trends in historical usage by the customer, a seasonally weighted average of computing resources that takes into account calendar year based changes by the customer, and combinations thereof.

19. The non-transitory computer readable medium according to claim 14, wherein determining the potential size of computing resource needs based upon analysis of customer-specific data comprises instructions that, when executed by at least one hardware processor, configure the at least one hardware processor to use at least one of a group consisting of machine learning algorithms, natural language processing algorithms, data science algorithms, and combinations thereof.

20. A computer-implemented system to predict cloud computing resources to add to a cloud computing system comprising:
a memory storage device storing program instructions; and
a hardware processor having circuitry and logic to execute said program instructions to predict the cloud computing resources to add to the cloud computing system, the hardware processor coupled to said memory storage device and in response to executing said program instructions, is configured to:
determine on a computer resource-by-resource basis the total current size of available computing resources;
determine on a computing resource-by-resource basis a predicted size of computing resources that are expected to be faulty;
determine on a computing resource-by-resource basis a confirmed size of computing resources already provisioned on a customer-by-customer basis;
determine on a computing resource-by-resource basis a workload size of computing resources to meet potential workload increases in computing resources;
determine on a computing resource-by-resource basis a potential size of needed computing resources on a customer-by-customer basis based upon analysis of customer-specific data; and
predict on a computing resource-by-resource basis the cloud computing resources needs to be added to the cloud computing system using the determinations on a resource-by-resource basis the total current size of available computing resources, the predicted size of computing resources that are expected to be faulty; the confirmed size of computing resources already provisioned; the workload size of computing resources to meet potential workload increases in computing resources; and the potential size of needed computing resources based upon analysis of customer-specific data,
wherein determining on a resource-by-resource basis the potential size of needed computing resources based upon analysis of customer-specific data comprises instructions that, when executed by at least one hardware processor, configure the at least one hardware processor to:
determine on a customer-by-customer basis a propensity of a customer to increase or decrease its cloud computing needs based upon analysis of customer-specific data; and
determine on a customer-by-customer basis a propensity size increase or decrease based upon the propensity of a customer to increase or decrease its cloud computing needs based upon analysis of customer-specific data.
